(19) United States
(12) Patent Application Publication
(10) Pub. No.: US 2006/0167125 A1
(43) Pub. Date: Jul. 27, 2006

(54) Method for the production of low-emission polyurethane soft foams

(75) Inventors: Stephan Bauer, Ostercappeln (DE); Raimund Ruppel, Dresden (DE); Eva Baum, Schwarzheide (DE); Jurgen Winkler, Schwarzheide (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 10/524,039

(22) PCT Filed: Jul. 24, 2003
(86) PCT No.: PCT/EP03/08090

§ 371 Date: Feb. 9, 2005

(30) Foreign Application Priority Data
Aug. 28, 2002 (DE) 102 40 186.1

(51) Int. Cl. C08G 18/00

(52) U.S. Cl. 521/172

(57) ABSTRACT

The present invention provides a process for producing low-emission flexible polyurethane foams having a reduced odor and reduced fogging by reacting a) polyisocyanates with b) compounds having at least two hydrogen atoms which are reactive toward isocyanate groups, c) blowing agents wherein polyether alcohols which have been prepared by addition of alkylene oxides onto compounds derived from renewable raw materials using DMC catalysts are used as compounds b) having at least two hydrogen atoms which are reactive toward isocyanate groups.

The present invention relates to a process for producing flexible polyurethane foams using polyether alcohols based on renewable raw materials, in particular castor oil.

Flexible polyurethane foams are used in many industrial fields, in particular for upholestery or acoustic insulation. They are usually produced by reacting polyisocyanates with compounds having at least two hydrogen atoms which are reactive toward isocyanate groups in the presence of blowing agents and, if desired, catalysts and customary auxiliaries and/or additives.

For ecological reasons, there is an increasing market demand for foams based on renewable raw materials. Such foams are usually produced using polyetherols which are prepared by addition of alkylene oxides onto compounds derived from renewable raw materials.

Examples of compounds derived from renewable raw materials are castor oil, polyhydroxy fatty acids, ricinoleic acid, oils modified with hydroxyl groups, e.g. grapeseed oil, black caraway oil, pumpkin kernel oil, borage seed oil, soybean oil, wood germ oil, rapeseed oil, sunflower oil, peanut oil, apricot kernel oil, pistachio oil, almond oil, olive oil, macadamia nut oil, avocado oil, sea buckthorn oil, sesame oil, hemp oil, hazelnut oil, evening primrose oil, wild rose oil, thistle oil, walnut oil, fatty acids and fatty acid esters modified with hydroxyl groups and based on myristoleic acid, palmitoleic acid, oleic acid, vaccenic acid, petroselinic acid, gadoleic acid, erucic acid, nervonic acid, linoleic acid, α- and γ-linolenic acid, stearidonic acid, arachidonic acid, timnodonic acid, clupanodonic acid, cervonic acid. Among these, castor oil has the greatest industrial importance.

The reaction of the compounds derived from renewable raw materials with the alkylene oxides can be carried out in a customary and known way. It is usual to mix the starting compound with a catalyst and to react this mixture with alkylene oxides. The addition reaction with the alkylene oxides usually occurs under the customary conditions, viz. at from 60 to 180° C., preferably from 90 to 140° C., in particular from 100 to 130° C., and pressures in the range from 0 to 20 bar, preferably in the range from 0 to 10 bar and in particular in the range from 0 to 5 bar.

As alkylene oxides, preference is given to using ethylene oxide, propylene oxide or any mixtures of these compounds.

As catalysts, preference is given to using basic compounds, among which potassium hydroxide has achieved the greatest industrial importance.

It is known from WO 00/44813 that multimetal cyanide compounds, frequently also referred to as DMC catalysts, can be used for the alkoxylation of castor oil.

The polyetherols for use in flexible foams preferably have a hydroxyl number of from 20 to 100 mg KOH/g at a viscosity in the range from 400 to 6000 mPa·s.

Flexible polyurethane foams produced from polyether alcohols which have been prepared on the basis of renewable raw materials such as castor oil using basic catalysts display very poor properties in respect of odor, emissions and fogging.

Thus, the preparation of castor oil polyetherols results in the formation of considerable amounts of the ring of ricinoleic acid ((R)-cis-12-hydroxy-9-octadecenoic acid).

This ring can be removed only incompletely by simple steam stripping. The polyether alcohols and the foams produced therefore display emissions, odor and fogging. For this reason, use of these polyetherols for the production of flexible foams for furniture and mattresses or flexible foam for automobile applications is not acceptable on the market. As an established commercial test method, the DaimlerChrysler test method PB VWL 709: “Analyse der flüchtigen Emissionen flüchtiger und kondensierbarer Substanzen aus Fahrzeuginnenraum Materialien mittels Thermodesorption” has become widely accepted.

The value for the emissions of volatile compounds will hereinafter be referred to as the VOC value (VOC=volatile organic compounds). The value for the emissions of condensible compounds will hereinafter be referred to as the FOG value. In the test method, a target VOC value of 100 ppm and a target FOG value of 250 ppm are specified for flexible foams. These requirements set down by the automobile industry are increasingly also required by the foam processing industry and foam manufacturers. Polyetherols based on renewable raw materials, in particular castor oil, and prepared by means of basic catalysis, for example by means of potassium hydroxide catalysis, display VOC and FOG values on thermodesorption which are above the specific target values. The cyclic fatty acid esters contribute substantially to the high VOC and FOG values.

Further disadvantages are that flexible polyurethane foams produced from polyether alcohols derived from renewable raw materials frequently display cracks or only an insufficient proportion of open cells. The opportunities for making changes to the formulation, frequently referred to as processing range, is restricted when using such compounds.

A further disadvantage is that flexible polyurethane foams prepared from polyether alcohols derived from renewable raw materials display a poor compressive set. For example, the compressive set of flexible slabstock foams determined in accordance with DIN EN 3386 is above 7% and after aging in accordance with DIN EN ISO 2440 is above 10%.

It has surprisingly been found that the abovementioned disadvantages did not occur when using polyether alcohols which had been prepared by addition of alkylene oxides onto compounds derived from renewable raw materials using DMC catalysts. It was not necessary to subject the polyether alcohols to steam stripping after their preparation.

The present invention accordingly provides a process for producing low-emission flexible polyurethane foams having reduced odor and reduced fogging by reacting
a) polyisocyanates with
b) compounds having at least two hydrogen atoms which are reactive toward isocyanate groups,
c) blowing agents
   wherein polyether alcohols which have been prepared by addition of alkylene oxides onto compounds derived from renewable raw materials using DMC catalysts are used as compounds b) having at least two hydrogen atoms which are reactive toward isocyanate groups.

The invention also provides the low-emission foams produced by the process of the present invention. These preferably have a maximum VOC value of 100 ppm, preferably 50 ppm and very preferably less than 20 ppm, and a maximum FOG value of 200 ppm, preferably 100 ppm and very preferably less than 50 ppm, in each case due to the constituents of the polyol used according to the present invention in the polyurethane. The values mentioned are determined in accordance with the DaimlerChrysler test method PB VWL 709: “Analyse der flüchtigen Emissionen flüchtiger und kondensierbarer Substanzen aus Fahrzeuginnenraum Materialien mittels Thermodesorption”. Furthermore, the foams produced by the process of the present invention have maximum odor values of the polyetherol used according to the present invention of less than or equal to 2.0, preferably less than or equal to 1.7. The test method for the odor value is given below.

The invention further provides for the use of polyether alcohols which have been prepared by addition of alkylene oxides onto compounds derived from renewable raw materials using DMC catalysts for the production of flexible polyurethane foams having reduced odor and emissions, with the maximum odor value of the polyetherol used according to the present invention preferably being less than or equal to 2.0, particularly preferably less than or equal to 1.7, and the flexible polyurethane foams produced from the polyetherol used according to the present invention having a maximum VOC value of 100 ppm, preferably 50 ppm and very preferably less than 20 ppm, due to the constituents of the polyetherol used according to the present invention in the polyurethane and a maximum FOG value of 200 ppm, preferably 100 ppm and very preferably less than 50 ppm, due to the constituents of the polyol used according to the present invention in the polyurethane. The values mentioned are determined by the DaimlerChrysler test method PB VWL 709: “Analyse der flüchtigen Emissionen flüchtiger und kondensierbarer Substanzen aus Fahrzeuginnenraum Materialien mittels Thermodesorption”.

The invention further provides for the use of polyether alcohols which have been prepared by addition of alkylene oxides onto compounds derived from renewable raw materials using DMC catalysts for the production of flexible polyurethane foams having reduced crack formation.

The invention further provides for the use of polyether alcohols which have been prepared by addition of alkylene oxides onto compounds derived from renewable raw materials using DMC catalysts for the production of flexible polyurethane foams having reduced compressive sets.

The invention further provides for the use of polyether alcohols which have been prepared by addition of alkylene oxides onto compounds derived from renewable raw materials using DMC catalysts for producing flexible polyurethane foams for use in motor vehicle interiors.

The invention further provides for the use of polyether alcohols which have been prepared by addition of alkylene oxides onto compounds derived from renewable raw materials using DMC catalysts for producing flexible polyurethane foams for use in the production of furniture and mattresses.

As compounds derived from renewable raw materials, use is made of, in particular, the above-described renewable or modified renewable raw materials such as oils, fatty acids and fatty acid esters which have a mean OH functionality of at least 2-16, preferably from 2 to 8 and very preferably from 2 to 4.

The polyether alcohols which are used according to the present invention and have been prepared by addition of alkylene oxides onto compounds derived from renewable raw materials using DMC catalysts preferably have a mean molecular weight in the range from 400 to 20000 g/mol, more preferably from 1000 to 8000 g/mol.

The products from the addition of alkylene oxides onto compounds derived from renewable raw materials using DMC catalysts preferably have a content of cyclic fatty acid esters of not more than 50 ppm, more preferably not more than 10 ppm.

The compounds derived from renewable raw materials are preferably selected from the group consisting of castor oil, polyhydroxy fatty acids, ricinoleic acid, oils modified with hydroxyl groups, e.g. grapeseed oil, black caraway oil, pumpkin kernel oil, borage seed oil, soybean oil, wood germ oil, rapeseed oil, sunflower oil, peanut oil, apricot kernel oil, pistachio oil, almond oil, olive oil, macadamia nut oil, avocado oil, sea buckthorn oil, sesame oil, hemp oil, hazelnut oil, evening primrose oil, wild rose oil, thistle oil, walnut oil, fatty acids and fatty acid esters modified with hydroxyl groups and based on myristoleic acid, palmitoleic acid, oleic acid, vaccenic acid, petroselinic acid, gadoleic acid, erucic acid, nervonic acid, linoleic acid, α- and γ-linolenic acid, stearidonic acid, arachidonic acid, timnodonic acid, clupanodonic acid, cervonic acid.

Examples of commercially available compounds which have been chemically modified by means of hydroxyl groups are Merginat® PV 204, 206 and 235, or the polyhydroxy fatty acid PHF 110 from Harburger Fettchemie.

Preference is given to using castor oil as compound derived from renewable raw materials.

According to the invention, polyether alcohols are prepared, as indicated, by addition of alkylene oxides onto H-functional starter substances in the presence of DMC catalysts.

The DMC catalysts are generally known and are described, for example, in EP 654 302, EP 862 947, WO 99/16775, WO 00/74845, WO 00/74843 and WO 00/74844.

As alkylene oxides, it is possible to use all known alkylene oxides, for example ethylene oxide, propylene oxide, butylene oxide, styrene oxide. Particular preference is given to using ethylene oxide, propylene oxide and mixtures of the compounds mentioned as alkylene oxides.

The starter substances used are the abovementioned H-functional compounds derived from renewable raw materials.

The addition reaction of the alkylene oxides in the preparation of the polyether alcohols used for the process of the present invention can be carried out by known methods. Thus, it is possible to use only one alkylene oxide for the preparation of the polyether alcohols. When a plurality of alkylene oxides are used, they can be added on in blocks, in which case the alkylene oxides are introduced individually in succession, or can be added on randomly, in which case the alkylene oxides are introduced simultaneously. It is also possible for both blocks and random sections to be incorporated in the polyether chain in the preparation of the polyether alcohols.

For the production of flexible polyurethane slabstock foams, preference is given to using polyether alcohols having a high content of secondary hydroxyl groups and a content of ethylene oxide units in the polyether chain of not more than 30% by weight, based on the weight of the polyether alcohols. These polyether alcohols preferably have a propylene oxide block at the end of the chain. Polyether alcohols used for the production of flexible polyurethane molded foams are, in particular, those having a high content of primary hydroxyl groups and an ethylene oxide end block in an amount of <10% by weight, based on the weight of the polyether alcohol.

In a preferred embodiment of the addition reaction of mixtures of at least two alkylene oxides, the ratio of the alkylene oxides to one another can be altered during the addition reaction, as described in DE 199 60 148 A1.

The addition reaction of the alkylene oxides is carried out under the customary conditions, at temperatures in the range from 60 to 180° C., preferably from 90 to 140° C., in particular from 100 to 130° C., and pressures in the range from 0 to 20 bar, preferably in the range from 0 to 10 bar and in particular in the range from 0 to 5 bar. The mixture of starter substance and DMC catalyst can be pretreated by stripping prior to commencement of the alkoxylation, as taught by WO 98/52689.

In a further embodiment, for example as described in DD 203734/735, one or more further starter alcohols can be metered in during the synthesis in addition to the alkylene oxides. These further starter alcohols may be identical to or different from those charged initially.

After the addition reaction of the alkylene oxides is complete, the polyether alcohol is worked up in a customary fashion by removing unreacted alkylene oxides and other volatile constituents, usually by distillation, steam stripping or gas stripping and/or other deodorization methods. If necessary, a filtration can also be carried out.

The production of the flexible polyurethane foams of the present invention can likewise be carried out by customary and known methods.

As regards the starting compounds used for the process of the present invention, the following details may be provided:

As polyisocyanates a), it is possible to use all isocyanates having two or more isocyanate groups in the molecule for the process of the present invention. Both aliphatic isocyanates such as hexamethylene diisocyanate (HDI) or isophorone diisocyanate (IPDI) or preferably aromatic isocyanates such as tolylene diisocyanate (TDI), diphenylmethane diisocyanate (MDI) or mixtures of diphenylmethane diisocyanate and polymethylenepolyphenylene polyisocyanates (crude MDI), preferably TDI and MDI, particularly preferably TDI, can be used. It is also possible to use isocyanates which have been modified by incorporation of urethane, uretdione, isocyanurate, allophanate, iretonimine and other groups, known as modified isocyanates. Preferred prepolymers are MDI prepolymers having an NCO content of from 20 to 35% or mixtures thereof with polymethylenepolyphenylene polyisocyanates (crude MDI).

The polyether alcohols b) which are used according to the present invention and are prepared by addition of alkylene oxides onto compounds derived from renewable raw materials using DMC catalysts can be used either alone or in combination with other compounds having at least two hydrogen atoms which are reactive toward isocyanate groups.

As compounds having at least two active hydrogen atoms b) which can be used together with the polyether alcohols used according to the present invention, it is possible to employ, in particular, polyester alcohols and preferably polyether alcohols having a functionality of from 2 to 16, in particular from 2 to 8, preferably from 2 to 4, and a mean molecular weight M_{W} in the range from 400 to 20000 g/mol, preferably from 1000 to 8000 g/mol.

The polyether alcohols which are, if desired, used together with the polyether alcohols used according to the present invention can be prepared by known methods, usually by catalytic addition of alkylene oxides, in particular ethylene oxide and/or propylene oxide, onto H-functional starter substances or by condensation of tetrahydrofuran. H-Functional starter substances used are, in particular, polyfunctional alcohols and/or amines. Preference is given to using water, dihydric alcohols, for example ethylene glycol, propylene glycol or butanediols, trivalent alcohols, for example glycerol or trimethylolpropane, or higher-hydric alcohols such as pentaerythritol, sugar alcohols, for example sucrose, glucose or sorbitol. Preferred amines are aliphatic amines having up to 10 carbon atoms, for example ethylenediamine, diethylenetriamine, propylenediamine, or amino alcohols such as ethanolamine or diethanolamine. As alkylene oxides, preference is given to using ethylene oxide and/or propylene oxide, with an ethylene oxide block frequently being added on at the end of the chain in the case of polyether alcohols which are used for producing flexible polyurethane foams. Catalysts used in the addition reaction of the alkylene oxides are, in particular, basic compounds, among which potassium hydroxide has achieved the greatest industrial importance. When a low content of unsaturated constituents in the polyether alcohols is desired, DMC catalysts can also be used as catalysts for preparing these polyether alcohols.

For particular application areas, in particular for increasing the hardness of the flexible polyurethane foams, it is also possible to make concomitant use of polymer-modified polyols. Such polyols can be prepared, for example, by in-situ polymerization of ethylenically unsaturated monomers, preferably styrene and/or acetonitrile, in polyether alcohols. Polymer-modified polyether alcohols also include polyether alcohols containing polyurea dispersions, which are preferably prepared by reaction of amines with isocyanates in polyols.

To produce flexible foams and integral foams, use is made of, in particular, bifunctional and/or trifunctional polyether alcohols. Rigid foams are produced using, in particular, polyether alcohols which have been prepared by addition of alkylene oxides onto tetrafunctional or higher-functional starters, e.g. sugar alcohols or aromatic amines.

To produce molded flexible foams and highly elastic flexible foams by the process of the present invention, preference is given to using bifunctional and/or trifunctional polyether alcohols which bear primary hydroxyl groups, preferably to an extent of over 50%, in particular polyether alcohols having an ethylene oxide block at the end of the chain or those based only on ethylene oxide.

To produce flexible slabstock foams by the process of the present invention, preference is given to using bifunctional and/or trifunctional polyether alcohols which bear secondary hydroxyl groups, preferably to an extent of over 90%, in particular polyether alcohols having a propylene oxide block or a random propylene oxide and ethylene oxide block at the end of the chain or those which are based only on propylene oxide.

The compounds b) having at least two active hydrogen atoms also include chain extenders and crosslinkers. Chain extenders and crosslinkers used are preferably 2- and 3-functional alcohols having molecular weights of from 62 to 800 g/mol, in particular in the range from 60 to 200 g/mol. Examples are ethylene glycol, propylene glycol, diethylene glycol, triethylene glycol, dipropylene glycol, tripropylene glycol, low molecular weight polypropylene oxide and polyethylene oxides, e.g. Lupranol® 1200, 1,4-butanediol, glycerol or trimethylolpropane. As crosslinkers, it is also possible to use diamines, sorbitol, glycerol, alkanolamines. If chain extenders and crosslinkers are used, they are preferably employed in an amount of up to 5% by weight, based on the weight of the compound having at least two active hydrogen atoms.

The process of the present invention is usually carried out in the presence of activators, for example tertiary amines or organic metal compounds, in particular tin compounds. As tin compounds, preference is given to using divalent tin salts of fatty acids, e.g. tin dioctoate, and organotin compounds such as dibutyltin dilaurate.

As blowing agent c) for producing the polyurethane foams, preference is given to using water which reacts with the isocyanate groups to liberate carbon dioxide. Water is preferably used in an amount of from 0.5 to 6% by weight, particularly preferably in an amount of from 1.5 to 5.0% by weight. Together with or in place of water, it is also possible to use physically active blowing agents, for example carbon dioxide, hydrocarbons such as n-pentane, isopentane or cyclopentane, cyclohexane, or halogenated hydrocarbons such as tetrafluoroethane, pentafluoropropane, heptafluoropropane, pentafluorobutane, hexafluorobutane or dichloromonofluoroethane. The amount of physical blowing agent is preferably in the range from 1 to 15% by weight, in particular from 1 to 10% by weight, and in this case the amount of water is preferably in the range from 0.5 to 10% by weight, in particular from 1 to 5% by weight. Among the physical blowing agents, preference is given to carbon dioxide which is preferably employed in combination with water.

To produce the flexible polyurethane foams of the present invention, stabilizers and auxiliaries and/or additives can usually also be used.

Suitable stabilizers are, in particular, polyether siloxanes, preferably water-soluble polyether siloxanes. These compounds generally have a structure in which a long-chain copolymer of ethylene oxide and propylene oxide is joined to a polydimethylsiloxane radical. Further foam stabilizers are described in U.S. Pat. Nos. 2,834,748, 2,917,480 and U.S. Pat. No. 3,629,308.

The reaction may, if desired, be carried out in the presence of auxiliaries and/or additives such as fillers, cell regulators, surface-active compounds and/or flame retardants. Preferred flame retardants are liquid flame retardants based on halogen-phosphorus compounds, e.g. trichloropropyl phosphate, trichloroethyl phosphate, and halogen-free flame retardants such as Exolit® OP 560 (Clariant International Ltd).

Further information on the starting materials, catalysts and auxiliaries and additives used may be found, for example, in the Kunststoff-Handbuch, Volume 7, Polyurethane, Carl-Hanser-Verlag, Munich, 1^{st} edition 1966, 2^{nd} edition 1983 and 3^{rd} edition 1993.

To produce the polyurethanes of the present invention, the organic polyisocyanates are reacted with the compounds having at least two active hydrogen atoms in the presence of the abovementioned blowing agents and, if desired, the catalysts and auxiliaries and/or additives.

In the production of the polyurethanes of the present invention, the isocyanate and the polyol component are usually combined in such an amount that the equivalence ratio of isocyanate groups to the sum of the active hydrogen atoms is from 0.7 to 1.25, preferably from 0.8 to 1.2.

The polyurethane foams are preferably produced by the one-shot process, for example with the aid of the high-pressure or low-pressure technique. The foams can be produced in open or closed metallic molds or by continuous application of the reaction mixture to conveyor belts to produce slabstock foams.

To produce molded flexible foams, it is particularly advantageous to employ the two-component method in which a polyol component and an isocyanate component are prepared and foamed. The components are preferably mixed at from 15 to 90° C., more preferably from 20 to 60° C. and particularly preferably from 20 to 35° C., and introduced into the mold or onto the conveyor belt. The temperature in the mold is usually in the range from 20 to 110° C., preferably from 30 to 60° C. and particularly preferably from 35 to 55° C.

Flexible slabstock foams can be foamed in discontinuous or continuous plants, for example by the Planiblock process, the Maxfoam process, the Draka-Petzetakis process and the Vertifoam process.

The flexible polyurethane foams produced by the process of the present invention have a significantly reduced odor, significantly reduced values for fogging and a significantly reduced crack formation together with an improved compressive set, both before and after aging, compared to otherwise identical products in which the polyether alcohols used according to the present invention have been prepared from renewable raw materials by means of basic catalysts. Furthermore, the foams of the present invention have a higher proportion of open cells, which is reflected, for example, in an increased air permeability.

The invention is illustrated by the following examples.

### EXAMPLES

Preparation of Polyether Alcohols Using DMC Catalysis

The following properties have been determined by the specified standards, internal test methods or measurement methods:

| | |
|---|---|
| Water content in % by weight: | DIN 51777 |
| Hydroxyl number in mg KOH/g: | DIN 53240 |
| Acid number in mg KOH/g: | DIN EN ISO 3682 |
| Viscosity (25° C.) in mPa · s: | DIN 51 550 |
| Color number Pt/Co: | DIN ISO 6271 |
| Alkalinity in ppm: | titrimetric |
| M_{w} in g/mol: | mean weight average |
| | molecular weight |
| | determined by means of |
| | gel permeation |
| Polydispersity D = M_{w}/M_{N} | determined by means of |
| | gel permeation |
| Odor: | test method PPU |
| | 03/03-04 of |
| | Feb. 15, 2002 |

Determination of the Odor by Test Method PPU 03/03-04 of Jan. 15, 2001

100 g of the polyetherol to be examined is weighed into a new, dry glass bottle (250 ml) having a screw cap. The determination of the odor is carried out at 25° C. Before opening the glass bottle, this is briefly swirled. After the subjective odor test, the glass bottle is once again closed tightly. The next test may take place only after 15 minutes. The assessment is carried out by a total of 5 fixed, nominated testers. The assessment of the odor is carried out according to the following scale:

| | |
|---|---|
| 1.0 | no odor |
| 1.3 | just discernible odor |
| 1.5 | discernible pleasant odor |
| 1.7 | pleasant slightly acrid odor |
| 2.0 | slightly unpleasant odor |
| 3.0 | unpleasant odor |
| 4.0 | smells strongly |
| 5.0 | stinks |

After the odor assessment of the testers, the odor value is determined by majority decision and documented. If no majority decision can be established, the odor evaluation is repeated at a later point in time. If the ability of a tester to evaluate the odor is restricted by dulling of senses, e.g. a cold, etc., the test is carried out by another nominated tester.

### Example 1

8750 g of castor oil (grade DAB from Alberdingk Boley, hydroxyl number: 160 mg KOH/g) were mixed with 50 g of a 5.97% strength suspension of a zinc hexacyanocobaltate (corresponding to 150 ppm of DMC catalyst, based on the product to be prepared) in a 20 liter stirred tank reactor and dewatered at 120° C. and a pressure of about 40 mbar until the water content was below 0.02% by weight. 400 g of propylene oxide were subsequently added and the commencement of the reaction, which could be recognised by a brief increase in temperature and a rapid drop in the reactor pressure, was awaited. At the same temperature, 16450 g of a mixture of 9250 g of propylene oxide and 2000 g of ethylene oxide were metered in over a period of 1.5 hours. After a constant reactor pressure had been reached, unreated monomers and other volatile constituents were distilled off under reduced pressure and the product was drained. The polyether alcohol was not worked up in an additional deodorization column.

The colorless polyether alcohol obtained had the following properties:

| hydroxyl number: | 70.8 mg KOH/g |
|---|---|
| acid number: | 0.007 mg KOH/g |
| water content: | 0.017% by weight |
| viscosity (25° C.): | 610 mPa · s |
| color number: | 72 mg of Pt/l |
| M_{w} | 2392 g/mol |
| polydispersity D: | 1.2208 |
| odor: | 1.9 |

### Example 2

The procedure of Example 1 was repeated, but 6300 g of castor oil DAB were reacted with 13840 g of a mixture of 11870 g of PO and 1970 g of EO. In addition, the polyether alcohol was worked up in a deodorization column.

The colorless polyether alcohol obtained had the following properties:

| hydroxyl number: | 50.9 mg KOH/g |
|---|---|
| acid number: | 0.007 mg KOH/g |
| water content: | 0.012% |
| viscosity (25° C.): | 718 mPa · s |
| color number: | 85 mg of Pt/l |
| M_{w} | 3053 g/mol |
| polydispersity D | 1.1625 |
| odor: | 1.5 |

### Example 3

The procedure of Example 1 was repeated, but 11250 g of castor oil DAB were reacted with 8750 g of propylene oxide. In addition, the polyether alcohol was worked up in a deodorization column.

The colorless polyether alcohol obtained had the following properties:

| hydroxyl number: | 91.0 mg KOH/g |
|---|---|
| acid number: | 0.007 mg KOH/g |
| water content: | 0.010% |
| viscosity (25° C.): | 597 mPa · s |
| color number: | 96 mg of Pt/l |
| M_{w} | 1865 g/mol |
| polydispersity D | 1.1872 |
| odor: | 1.5 |

### Example 4 (Comparative Example)

16 kg of castor oil DAB were admixed with 60 g of solid potassium hydroxide in a 50 liter stirred tank reactor and stirred at 110° C. for half an hour. After checking the water content, 5.1 kg of propylene oxide were introduced at such a rate that the reactor pressure did not exceed 7 bar. A mixture of 28.6 kg of propylene oxide and 5.5 kg of ethylene oxide were subsequently introduced, once again at such a rate that the pressure did not exceed 7 bar. After an after-reaction phase, volatile constituents and unreacted alkylene oxides were distilled off under reduced pressure and the contents of the reactor were admixed with 4% by weight of water. The alkaline reaction mixture was neutralized with 80 mol % of the stoichiometric amount, based on the alkalinity, of phosphoric acid and 0.1% by weight of Ambosol and the salts formed were filtered off via a deep bed filter.

In addition, the polyether alcohol was worked up in a deodorization column.

The colorless polyether alcohol obtained had the following properties:

| hydroxyl number: | 51.8 mg KOH/g |
|---|---|
| acid number: | 0.738 mg KOH/g |
| water content: | 0.046% |
| viscosity (25° C.): | 593 mPa · s |
| color number Pt/Co: | 356 |
| Alkalinity: | 22 mg of K/kg |
| M_{w} | g/mol (data to follow) |
| polydispersity D | (data to follow) |
| odor: | 1.7 |

### Example 5 (Comparative Example)

The procedure of Example 4 was repeated, but 26.0 kg of castor oil were reacted with 17.0 kg of ethylene oxide and 17.0 kg of propylene oxide.

The polyetherol was not worked up in a deodorization column.

The colorless polyether alcohol obtained had the following properties:

| hydroxyl number: | 82.6 mg KOH/g |
|---|---|
| acid number: | 0.840 mg KOH/g |
| water content: | 0.023% |
| viscosity (25° C.): | 535 mPa · s |
| color number Pt/Co: | 346 |
| Alkalinity: | 64 mg of K/kg |
| M_{w} | g/mol (data to follow) |
| polydispersity D | (data to follow) |
| odor: | 3.0 |

Production of Flexible Polyurethane Foams

### Examples 6 to 8 (Comparative Examples) and Examples 9 to 10

The starting materials listed in Table 1 were reacted in the ratios specified in Table 1.

All components apart from the isocyanate Lupranat® T80A and Desmodur®T65 were firstly combined by intensive mixing to form a polyol component. The Lupranat® T80 A and, if applicable, Desmodur® T65 were then added while stirring and the reaction mixture was poured into an open mold in which it foamed to produce the polyurethane foam. The properties of the foams obtained are shown in Table 1.

The following properties were determined by the specified standards, operating procedures and test methods:

| | |
|---|---|
| Foam density in kg/m³ | DIN EN ISO 845 |
| VOC ricinoleic acid ring in ppm | PB VWL 709 |
| FOG ricinoleic acid ring in ppm | PB VWL 709 |
| air permeability in dm³/min | DIN EN ISO 7231 |
| compressive strength, | |
| 40% deformation in kPa | DIN EN ISO 2439 |
| indentation hardness, | |
| 25% deformation | DIN EN ISO 2439 |
| indentation hardness, | |
| 40% deformation | DIN EN ISO 2439 |
| indentation hardness, | |
| 65% deformation | DIN EN ISO 2439 |
| elongation in % | DIN EN ISO 1798 |
| tensile strength in kPa | DIN EN ISO 1798 |
| rebound resilience in % | DIN EN ISO 8307 |
| compressive set in % | DIN EN ISO 3386 |
| wet compressive set in % | operating |
| | procedure |
| | AA U10-131-041 |
| | of Feb. 6, 2002 |

Determination of the wet compressive set in accordance with the operating procedure AA U10-131-041 of Feb. 6, 2002:

The height of the foam test specimens having dimensions of 50 mm×50 mm×25 mm was determined at a previously marked point by means of a sliding caliper or caliper gauge. The test specimens are subsequently placed between two pressure plates and compressed to a height of 7.5 mm with the aid of spacers using a cladding apparatus.

Storage at 50° C. and 95% relative atmospheric humidity in a controlled atmosphere cabinet commences immediately after clamping. After 22 hours, the foam test specimens are quickly removed from the clamping apparatus and placed on a surface having low thermal conduction (tray) for 30 minutes in the standard atmosphere to allow relaxation. The height at the marked point is subsequently redetermined using the same measurement method.

The wet compressive set is expressed as a ratio of the deformation and is calculated as follows:
Wet compressive set=h₀−h_{R}*100/(h₀−7.5 mm) in %
h₀ original height in mm

h_{R} height of the test specimen after the test, in mm

TABLE 1

| | | Ex. 6 | Ex. 7 | Ex. 8 | | |
|---|---|---|---|---|---|---|
| | OHN | (C) | (C) | (C) | Ex. 9 | Ex. 10 |
| Lupranol ® 2080 | | | | | 50.00 | |
| Polyether, prepared as | 82.6 | 100.00 | | | | |
| described in Example 5 | | | | | | |
| Polyether, prepared as | 51.8 | | 100.00 | 100.00 | | |
| described in Example 4 | | | | | | |
| Polyether, prepared as | 91.0 | | | | 50.00 | |
| described in Example 3 | | | | | | |
| Polyether, prepared as | 70.8 | | | | | 100.00 |
| described in Example 1 | | | | | | |
| Tegoamin ® B4900 | 0 | 1.40 | 0.80 | 0.80 | 1.20 | 1.20 |
| Niax ® A1 | 560 | 0.05 | 0.05 | 0.05 | 0.05 | 0.05 |
| Dabco ® 33LV | 425.8 | 0.15 | 0.15 | 0.15 | 0.20 | 0.20 |
| Kosmos ® 29 | 0 | 0.23 | 0.20 | 0.23 | 0.23 | 0.30 |
| Water (added.) | 6233 | 3.70 | 2.00 | 2.00 | 3.80 | 3.80 |

| | | | | | |
|---|---|---|---|---|---|
| Lupranat ® T80A index | | 110 | | 112 | 112 |
| Lupranat ® T80A : Desmodur ® T65 | 113 | | 113 | | |
| 1:1 index | | | | | |
| Comment | | | ruptured | | |
| Cream time in s | 13 | 8 | 9 | 12 | 17 |
| Fiber time in s | 75 | 105 | 100 | 90 | 90 |
| Rise time in s | 85 | 120 | 120 | 95 | 100 |
| Air permeability in dm³/min | 69 | 48 | | 132 | 144 |
| VOC ricinoleic acid ring in ppm | 82 | 105 | | 0 | 0 |
| FOG ricinoleic acid ring in ppm | 3239 | 354 | | 0 | 0 |
| Foam density in kg/m³ | 25.3 | 43.7 | | 25.9 | 25.5 |
| Tensile strength in kPa | 71 | 55 | | 80 | 82 |
| Elongation in % | 76 | 139 | | 80 | 90 |
| Compressive strength, 40% | 4.7 | 2.7 | | 4.5 | 4.1 |
| deformation, in kPa | | | | | |
| Compressive set in % | 8.8 | 6.5 | | 3.1 | 3.0 |
| Wet compressive set | 25.3 | 23.2 | | 6.9 | 7.0 |
| Rebound resilience in % | 26 | 45 | | 45 | 42 |
| Indentation hardness, 25% | 172 | 73 | | 144 | 116 |
| deformation | | | | | |
| Indentation hardness, 40% | 249 | 108 | | 180 | 147 |
| deformation | | | | | |
| Indentation hardness, 65% | 513 | 248 | | 353 | 292 |
| deformation | | | | | |
| Aging under hot and humid | | | | | |
| conditions | | | | | |
| in accordance with DIN EN ISO 2240 | | | | | |
| Compressive strength, 40% | 2.5 | 1.6 | | 3.1 | 3.0 |
| deformation, in kPa | | | | | |
| Tensile strength in kPa | 65 | 35 | | 88 | 90 |
| Elongation in % | 70 | 130 | | 140 | 143 |
| Compressive set in % | 18.3 | 12.4 | | 3.0 | 3.1 |

Notes on the table:
Lupranol ® 2080: polyetherol having a hydroxyl number of 48 mg KOH/g and a viscosity of 540 mPa · s (BASF Aktiengesellschaft)
Dabco ® 33 LV: 1,4-diazabicyclo[2.2.2]-octane (33%) in dipropylene glycol (67%) (Air Products and Chemicals, Inc.)
Niax ® A1: bis(2-dimethylaminoethyl) ether (70%) in dipropylene glycol. (30%) (Crompton Corporation)
Kosmos ® 29: tin(II) salt of ethylhexanoic acid (Degussa AG)
Tegostab ® B 4900: silicone stabilizer (Degussa AG)
Lupranat ® T80: tolylene 2,4-/2,6-diisocyanate mixture in a ratio of 80:20 (BASF Aktiengesellschaft)
Desmodur ® T65: tolylene 2,4-/2,6-diisocyanate mixture in a ratio of 65:35 (BAYER AG)

1. A process for producing a low-emission flexible polyurethane foam by reacting
a) a polyisocyanate with
b) a compound having at least two hydrogen atoms which are reactive toward an isocyanate group,
wherein said compound is a polyether alcohol which has been prepared by addition of an alkylene oxide to a compound derived from renewable raw materials selected from the group consisting of castor oil, polyhydroxy fatty acids, ricinoleic acid, hydroxyl-modified oils, grapeseed oil, black caraway oil, pumpkin seed oil, borage seed oil, soybean oil, wheat germ oil, rapeseed oil, sunflower oil, peanut oil, apricot kernel oil, pistachio nut oil, almond oil, olive oil, macadamia nut oil, avocado oil, sea buckthorn oil, sesame oil, hemp oil, hazelnut oil, evening primrose oil, wild rose oil, hemp oil, safflower oil, walnut oil, and hydroxyl-modified fatty acids and fatty acid esters based on myristoleic acid, palmitoleic acid, oleic acid, vaccenic acid, petroselinic acid, gadoleic acid, erucic acid, nervonic acid, linoleic acid, α- and γ-linolenic acid, stearidonic acid, arachidonic acid, timnodonic acid, clupanodonic acid and cervonic acid using a DMC catalyst.

2. A process as claimed in claim 1, wherein said polyether alcohol has a mean molecular weight M_{w} in the range from 400 to 20 000 g/mol.

3. A process as claimed in claim 1, wherein said polyether alcohol has a mean molecular weight in the range from 1000 to 8000 g/mol.

4. A process as claimed in claim 1, wherein said polyether alcohol has a content of cyclic fatty acid esters of not more than 50 ppm.

5. A process as claimed in claim 1, wherein said polyether alcohol has a content of cyclic fatty acid esters of not more than 10 ppm.

6. A process as claimed in claim 1, wherein said low-emission flexible polyurethane foam has a compressive set of not more than 7%.

7. A process as claimed in claim 1, wherein said low-emission flexible polyurethane foam has a compressive set, after aging in accordance with DIN EN ISO 2440, of not more than 10%.

8. A low-emission flexible polyurethane slabstock foam produced by the process as claimed in claim 1.

9. A motor vehicle comprising said low-emission flexible polyurethane slabstock foam as claimed in claim 8.

10. A furniture or a mattress comprising said low-emission flexible polyurethane slabstock foam as claimed in claim 8.

11-12. (canceled)

13. The low-emission flexible polyurethane slabstock foam as claimed in claim 8 having reduced crack formation.

14. The low-emission flexible polyurethane slabstock foam as claimed in claim 8 having a reduced odor and a reduced fogging value.
